(19) United States
(12) Patent Application Publication
(10) Pub. No.: US 2026/0048804 A1
(43) Pub. Date: Feb. 19, 2026

(54) Motorcycle Type Vehicle

(71) Applicant: Bayerische Motoren Werke Aktiengesellschaft, Muenchen (DE)

(72) Inventor: Sebastien MARTIN, Muenchen (DE)

(21) Appl. No.: 19/102,909

(22) PCT Filed: Sep. 27, 2023
(86) PCT No.: PCT/EP2023/076625

§ 371 Date: Feb. 11, 2025

(30) Foreign Application Priority Data
Oct. 11, 2022 (DE) 10 2022 126 233.2

(51) Int. Cl. B62J 17/10

(52) U.S. Cl. CPC B62J 17/10

(57) ABSTRACT

A motorcycle-type vehicle has at least one laterally arranged air guide element. The air guide element has an internal flow channel which ends at an outer surface of the air guide element in an opening which acts as an air outlet. The flow channel is connected or can be connected in a fluid-conducting manner to an air inlet which is formed or arranged at a distance from the air guide element.

### BACKGROUND AND SUMMARY

The present invention relates to a motorcycle-type of vehicle, in particular a motorcycle.

Aerodynamically effective airfoil devices for motorcycles are known from the prior art. For example, DE 10 2019 105 755 A1 discloses such an airfoil device, in particular for a tilting vehicle, with at least one aerodynamically effective airfoil body arranged on a support structure of the vehicle, around which ambient air flows when the vehicle is moving. Such laterally arranged wings on motorcycles are also called “winglets”. It has been found that when cornering, negative aerodynamic forces arise on the inner wing profile due to the leaning position, which push the motorcycle out of the curve in the direction of centrifugal force, which has a negative effect on rideability.

It is therefore the object of the present invention to provide a motorcycle-type vehicle which also operates aerodynamically optimally when cornering or in a leaning position.

This object is achieved by a motorcycle-type vehicle according to the independent claim(s). Further advantages and features can be found in the dependent claims, the description and the accompanying figures.

According to the invention, a motorcycle-type vehicle comprises at least one laterally arranged air guide element, wherein the air guide element has an internal flow channel which ends at an outer surface of the air guide element in an opening which acts as an air outlet, and wherein the flow channel is connected or can be connected in a fluid-conducting manner to an air inlet which is formed or arranged at a distance from the air guide element. Such air guide elements, which are arranged on the side of the motorcycle, are also known as “winglets” (small wings). When cornering or in the event of a leaning position (of the motorcycle/motorbike), negative aerodynamic forces can occur with conventional winglets, which pull or push the motorcycle out of the curve in the direction of centrifugal force, which has a negative effect on rideability. The aim is therefore to eliminate the effect of the internal air guide element as far as possible, either temporarily or as required. The fact that there is a higher pressure on the inside of the motorcycle than on the outside when cornering is used for this purpose. In particular, an overpressure is created on the road side, i.e., on the inside, for example at the front edge of the fairing, if present, which can cause a flow from the air inlet via the internal flow channel to the air outlet. This can be used to cause the flow on the inner sash to dissipate. The effect of the internal air guide element is thus interrupted and the negative effects described above do not occur. If there is no pressure gradient as described above, there is little or no flow through the air guide element and the air guide element can operate normally, for example when traveling straight ahead.

Ideally, the respective inlet is not arranged or designed in such a way that a dynamic pressure is created or applied, which would cause a constant flow through the air guide element.

According to a preferred embodiment, the motorcycle-type vehicle has at least one laterally arranged air guide element, which is designed to allow air to flow through it. Motorcycle-type vehicles of the kind in question are in particular scooters or above all motorcycles, wherein tilting vehicles such as LNM vehicles (LNM=Lean Multiwheel) are also understood by this.

As already mentioned, the air guide element is conveniently designed as a wing or winglet. In principle, such an air guide element is primarily used to generate downforce. Preferably, the air guide elements protrude at an angle which is dimensioned in such a way that the air guide elements generate maximum downforce in a certain leaning position. Viewed from the front, along the direction of travel, the air guide elements are preferably inclined slightly downwards.

The air inlet is preferably arranged on the same side of the motorcycle-type vehicle as the air guide element connected to it in a fluid-conducting manner. This makes it possible to use the higher pressure on the inside when leaning to build up a pressure gradient, which causes the air to escape from the internal air guide element.

Typically, the air guide element has an upper side and an underside. Preferably, the at least one opening, which represents the air outlet, is formed on the underside. This allows the desired flow separation to be achieved effectively. Alternatively or additionally, however, it is also possible to provide one or more such openings on the upper side.

Preferably, the at least one opening is arranged in the front area of the air guide element. The term “in the front area” refers to the direction of travel. This allows the flow to be released as early as possible, thereby eliminating the aerodynamic forces of the internal air guide element.

According to one embodiment, the air guide element has a longitudinal extension direction, wherein a plurality of openings are formed along and/or transverse to the longitudinal extension direction. If necessary, several rows of openings can be formed, wherein the openings can also be of different sizes. Optimal geometries of the openings as well as shapes and/or sizes are preferably developed in the simulation. According to preferred embodiments, the opening or openings are round, in particular circular or also slot-shaped, angular or the like.

According to one embodiment, the motorcycle-type vehicle comprises an external flow channel that ends in at least one opening, which acts as the air inlet. The external flow channel is connected to the internal flow channel in a fluid-conducting manner. The internal flow channel is connected to the air inlet via the external flow channel.

The air inlet is formed, for example, on a fairing of the motorcycle. As already mentioned, the air inlet is conveniently arranged at a distance from the air outlet, which is formed in the air guide element. This enables optimum positioning of the air inlet where the pressure in the leaning position is as high as possible. In this way, the pressure gradient can be realized, which enables the air to flow through the air guide element and thus causes the flow to be released.

According to a preferred embodiment, the air inlet is arranged below the respective air guide element when viewed along a vertical axis. It has been found that this enables particularly effective flow separation on the inner blade.

Further advantages and features can be found in the following description of a motorcycle-type vehicle with reference to the attached figures.

### BRIEF DESCRIPTION OF THE DRAWINGS

FIG. 1 shows an embodiment of a motorcycle in a leaning position seen from the front;

FIG. 2 shows the section A-A sketched in FIG. 1; and

FIG. 3 shows the section B-B sketched in FIG. 1.

### DETAILED DESCRIPTION OF THE DRAWINGS

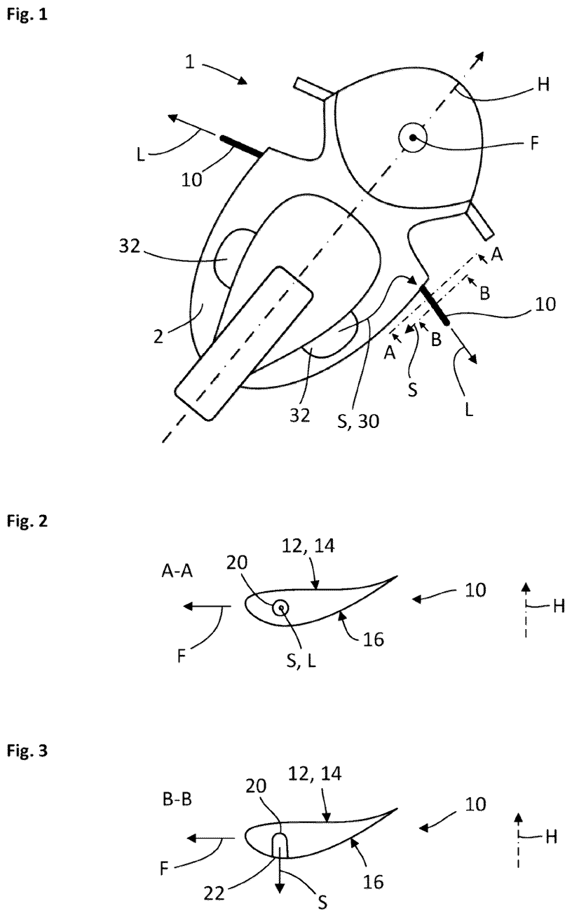

FIG. 1 is a schematic view of a motorcycle-type vehicle 1 in a leaning position. The motorcycle extends along a vertical axis H, which is inclined to the right. A rider is not shown here. The reference sign F denotes a direction of travel, which in the present case extends directly out of the plane of the drawing. It can be seen that an air guide element 10 is formed on both sides of the vertical axis or center axis H of the motorcycle 1. The air guide elements 10, which are inclined slightly downwards, each extend along a longitudinal direction L. Two air inlets 32 are sketched in a fairing 2 of the motorcycle 1, wherein it is shown schematically that a flow S is formed from the inner air inlet 32 in the direction of the inner air guide element 10. The flow S runs, for example, along an external flow channel 30 into the corresponding air guide element 10; see in particular sections A-A and B-B.

FIG. 2 shows section A-A, as sketched in FIG. 1. The air guide element 10, which is designed as a wing or winglet, can be seen in section, in which an internal flow channel 20 is formed along its longitudinal direction L, which ends in an opening or an air outlet 22, see also FIG. 3 in this respect. The air guide element 10 has an outer surface 12, which comprises an upper side 14 and an underside 16. The opening 22 is preferably formed on the underside 16 and, in relation to a direction of travel F, more towards the front of the air guide element 10. In a leaning position, there is an increase in pressure on the inside, which is used in the present case to cause the flow on the inside wing or on the inside air guide element 10 to be removed. For this purpose, the pressure gradient is used to cause a flow from the air inlet 32 to the air outlet 22, wherein the air outlet 22 on the air guide element 10 causes the flow to break off at this element. This therefore-temporarily-loses its aerodynamic effectiveness and the counterproductive aerodynamic forces in a leaning position, which cause the motorcycle to be pulled or pushed out of the curve in the direction of the centrifugal force, are eliminated. The great advantage is that the effect described above does not occur if there is no such pressure gradient, as is the case, for example, with the air guide element on the outside of the bend or when traveling straight ahead. However, it should be noted that the air inlet is not arranged in such a way that a dynamic pressure is created, which would cause a constant flow through the air guide element.

### LIST OF REFERENCE SIGNS

1 motorcycle-type vehicle
2 fairing
10 air guide element
12 outer surface
14 upper side
16 underside
20 internal flow channel
22 air outlet
30 external flow channel
32 air inlet
S flow (direction)
L longitudinal extension direction
H vertical axis, center axis
F direction of travel

1. -10. (canceled)

11. A motorcycle-type vehicle, comprising:
at least one laterally arranged air guide element,
wherein the air guide element has an internal flow channel which ends at an outer surface of the air guide element in at least one opening which acts as an air outlet, and
wherein the internal flow channel is connected or is connectable in a fluid-conducting manner to an air inlet which is configured or arranged at a distance from the air guide element.

12. The motorcycle-type vehicle according to claim 11, wherein
the motorcycle-type vehicle has at least one laterally arranged air guide element on each side.

13. The motorcycle-type vehicle according to claim 11, wherein the air guide element is designed as a wing.

14. The motorcycle-type vehicle according to claim 12, wherein
the air inlet is arranged, in each case, on the same side of the motorcycle type vehicle as the air guide element connected thereto in a fluid-conducting manner.

15. The motorcycle-type vehicle according to claim 11, wherein
the air guide element comprises an upper side and an underside, and
the at least one opening is formed on the underside.

16. The motorcycle-type vehicle according to claim 11, wherein
the at least one opening is arranged in a front region of the air guide element.

17. The motorcycle-type vehicle according to claim 11, wherein
the air guide element has a longitudinal extension direction, and
a plurality of openings is formed along and/or transversely to the longitudinal extension direction.

18. The motorcycle-type vehicle according to claim 11, further comprising:
an external flow channel which ends in at least one opening which acts as the air inlet.

19. The motorcycle-type vehicle according to claim 11, wherein
the air inlet is formed in a fairing of the motorcycle-type vehicle.

20. The motorcycle-type vehicle according to claim 11, wherein
the air inlet is arranged below a respective air guide element when viewed along a vertical axis.
